(19) United States
(12) Patent Application Publication
(10) Pub. No.: US 2023/0112699 A1
(43) Pub. Date: Apr. 13, 2023

(54) CONFIDENTIAL-INFORMATION PROCESSING SYSTEM, ENCRYPTION APPARATUS, ENCRYPTION METHOD AND COMPUTER READABLE MEDIUM

(71) Applicant: Mitsubishi Electric Corporation, Tokyo (JP)

(72) Inventor: Ryo HIROMASA, Tokyo (JP)

(73) Assignee: Mitsubishi Electric Corporation, Tokyo (JP)

(21) Appl. No.: 17/964,310

(22) Filed: Oct. 12, 2022

Related U.S. Application Data
(63) Continuation of application No. PCT/JP2020/022376, filed on Jun. 5, 2020.

(51) Int. Cl. H04L 9/40

(52) U.S. Cl. CPC H04L 9/40

(57) ABSTRACT

An encryption apparatus (400) generates ciphertext data C of plaintext data x by [C=B·R+E+x·G], using a matrix B included in an encryption key PK used for homomorphic computation, a random-number matrix R, a random-number matrix E, and a tensor product G of a predetermined vector and a predetermined identity matrix. A circuit-confidentiality homomorphic computation apparatus (500) performs the homomorphic computation for the plaintext data x, using the encryption key PK and the ciphertext data C, and generates ciphertext data C_{X} as a computation result of the homomorphic computation.

### CROSS REFERENCE TO RELATED APPLICATIONS

This application is a Continuation of PCT International Application No. PCT/JP2020/022376 filed on Jun. 5, 2020, which is hereby expressly incorporated by reference into the present application.

### TECHNICAL FIELD

The present disclosure relates to a confidential-information processing system.

### BACKGROUND ART

Homomorphic cipher is a cipher technique which can compute data while the data remains encrypted. Nowadays, a cloud service has started being in use widely. It is supposed that data is encrypted and stored on cloud because of concern about cracking or concern about reliability on the cloud. The homomorphic cipher can implement computation on encrypted data without decryption. Therefore, it is possible to utilize the cloud service without impairing security, by using the homomorphic cipher.

The homomorphic cipher which satisfies circuit confidentiality is an encryption technique achieving security which prevents information on a computation process from leaking from a computation result which remains encrypted, for enhancing the security of the homomorphic cipher.

Especially, strong circuit confidentiality is said to be satisfied by the homomorphic cipher achieving security which prevents information on homomorphic computation from leaking from a result of the homomorphic computation on a ciphertext which is not generated using encryption algorithm, among the homomorphic ciphers which satisfy the circuit confidentiality. At a time of performing computation while keeping a state being encrypted, the homomorphic cipher which satisfies the strong circuit confidentiality is realized by computation using homomorphic cipher which satisfies normal circuit confidentiality (that is, the circuit confidentiality is established only for a ciphertext generated by the encryption algorithm), while keeping the state being encrypted, after legitimacy of input (specifically, a fact that an encryption key and the ciphertext which serve as inputs to computation are generated by key generation algorithm and encryption algorithm, respectively) is confirmed.

An initial configuration example of the homomorphic cipher which satisfies the strong circuit confidentiality is described in Non-Patent Literature 1. A configuration described in Non-Patent Literature 1 has a problem that the homomorphic computation can be performed only on ciphertexts which have been encrypted using the same key. A configuration in Non-Patent Literature 2 has solved this problem. Non-Patent Literature 2 describes a configuration of strong-circuit-confidentiality homomorphic cipher which can perform the homomorphic computation also on ciphertexts which have been encrypted using different encryption keys.

### CITATION LIST

### Non-Patent Literature

Non-Patent Literature 1: R. Ostrovsky, A. Paskin-Cherniaysky, B. Paskin-Cherniaysky. “Maliciously Circuit-private FHE”. InCRYPTO, pages 536-553, 2014.
Non-Patent Literature 2: W. Chongchitmate, R. Ostrovsky. “Circuit-private Multi-key FHE”. InPKC, pages 241-270, 2017.
Non-Patent Literature 3: Z. Brakerski, S. Halevi, A. Polychroniadou. “Four Round Secure Computation without Setup”. In TCC, pages 645-677, 2017.

### SUMMARY OF INVENTION

### Technical Problem

In conventional circuit-confidentiality homomorphic cipher described in Non-Patent Literature 2, security is on a basis of a unique calculation problem called a Decisional Small Polynomial Ratio (DSPR) problem. It is known that this problem can be easily broken using a quantum computer. Especially, in a homomorphic cipher technique described in Non-Patent Literature 2, the security of the circuit-confidentiality homomorphic cipher used as a constituent depends on difficulty of the DSPR problem. Therefore, there is a problem that even the homomorphic cipher itself which satisfies the strong circuit confidentiality is not secure against the quantum computer.

The present disclosure mainly aims to solve such a problem. Specifically, the present disclosure mainly aims to realize a strong-circuit-confidentiality homomorphic cipher technique which can perform homomorphic computation on ciphertexts encrypted using different encryption keys and is secure against a quantum computer.

### Solution to Problem

A confidential-information processing system according to the present disclosure includes:

an encryption apparatus to generate ciphertext data C of plaintext data x by an equation 1, using a matrix B included in an encryption key PK used for homomorphic computation, a random-number matrix R, a random-number matrix E, and a tensor product G of a predetermined vector and a predetermined identity matrix

C=B·R+E+x·G equation 1; and
a circuit-confidentiality homomorphic computation apparatus to perform the homomorphic computation for the plaintext data x, using the encryption key PK and the ciphertext data C, and generate ciphertext data C_{X} as a computation result of the homomorphic computation.

### Advantageous Effects of Invention

According to the present disclosure, it is possible to realize a strong-circuit-confidentiality homomorphic cipher technique which can perform homomorphic computation on ciphertexts encrypted using different encryption keys and is secure against a quantum computer.

### BRIEF DESCRIPTION OF DRAWINGS

FIG. 1 is a diagram illustrating a configuration example of a confidential-information processing system according to a first embodiment.

FIG. 2 is a diagram illustrating a functional configuration example of a public-parameter generation apparatus according to the first embodiment.

FIG. 3 is a diagram illustrating a functional configuration example of a key generation apparatus according to the first embodiment.

FIG. 4 is a diagram illustrating a functional configuration example of an encryption apparatus according to the first embodiment.

FIG. 5 is a diagram illustrating a functional configuration example of a circuit-confidentiality homomorphic computation apparatus according to the first embodiment.

FIG. 6 is a diagram illustrating a functional configuration example of a decryption apparatus according to the first embodiment.

FIG. 7 is a flowchart illustrating a generation process and a storage process of a public parameter according to the first embodiment.

FIG. 8 is a flowchart illustrating a generation process and a storage process of an encryption key and a decryption key according to the first embodiment.

FIG. 9 is a flowchart illustrating a ciphertext generation process and a storage process according to the first embodiment.

FIG. 10 is a flowchart illustrating a homomorphic computation process and a decryption process according to the first embodiment.

FIG. 11 is a diagram illustrating a hardware configuration example of a public-parameter generation apparatus and so on according to the first embodiment.

### DESCRIPTION OF EMBODIMENTS

Hereinafter, an embodiment will be described with reference to the drawings. In the following description of the embodiment and the drawings, parts assigned by the same reference numerals indicate the same parts or corresponding parts.

### First Embodiment

### *** Description of Configuration ***

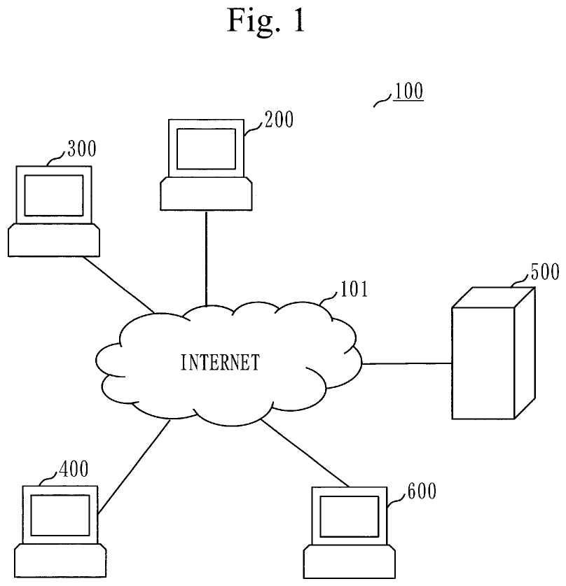

FIG. 1 illustrates a configuration example of a confidential-information processing system 100 according to the present embodiment.

The confidential-information processing system 100 includes a public-parameter generation apparatus 200, a key generation apparatus 300, an encryption apparatus 400, a circuit-confidentiality homomorphic computation apparatus 500, and a decryption apparatus 600.

The Internet 101 is a communication path connecting the public-parameter generation apparatus 200, the key generation apparatus 300, a plurality of encryption apparatuses 400, the circuit-confidentiality homomorphic computation apparatus 500, and the decryption apparatus 600 with each other.

The Internet 101 is an example of a network. Instead of the Internet 101, a different type of network may be used.

For example, the public-parameter generation apparatus 200 is a PC (Personal Computer). The public-parameter generation apparatus 200 generates a public parameter used for generating an encryption key, a decryption key, and a ciphertext. Then, the public-parameter generation apparatus 200 transmits the public parameter to the key generation apparatus 300, the encryption apparatus 400, and the circuit-confidentiality homomorphic computation apparatus 500 via the Internet 101. Note that, this public parameter may be directly sent by postal mail.

For example, the key generation apparatus 300 is a PC. The key generation apparatus 300 generates the encryption key used for encryption, and the decryption key. Then, the key generation apparatus 300 transmits the encryption key to the encryption apparatus 400 and the circuit-confidentiality homomorphic computation apparatus 500 and transmits the decryption key to the decryption apparatus 600, via the Internet 101. Note that, the encryption key and the decryption key may be directly sent by postal mail.

Since the decryption key is secret information, the decryption key is stored inside of the key generation apparatus 300 and the decryption apparatus 600 so that it does not leak.

For example, the encryption apparatus 400 is a PC. The encryption apparatus 400 generates ciphertext data by encrypting plaintext data obtained from a sensor or the like in a factory, with use of the public parameter and the encryption key which are stored. Then, the encryption apparatus 400 transmits the ciphertext data to the circuit-confidentiality homomorphic computation apparatus 500. Below, the ciphertext data may be simply referred to as a ciphertext.

Note that, an operation procedure of the encryption apparatus 400 is equivalent to an encryption method. Further, a program which realizes an operation of the encryption apparatus 400 is equivalent to an encryption program.

For example, the circuit-confidentiality homomorphic computation apparatus 500 is a computer including a large-volume storage medium. The circuit-confidentiality homomorphic computation apparatus 500 functions also as a data storage device. That is, the circuit-confidentiality homomorphic computation apparatus 500 stores the ciphertext data when it is requested to store the ciphertext data by the encryption apparatus 400.

The circuit-confidentiality homomorphic computation apparatus 500 performs homomorphic computation on the ciphertext data which has been stored (hereinafter, referred to as stored ciphertext data). That is, the circuit-confidentiality homomorphic computation apparatus 500 generates ciphertext data which is a result of computation on plaintext data of the stored ciphertext data, from the stored public parameter and the stored ciphertext data. Then, the circuit-confidentiality homomorphic computation apparatus 500 transmits the generated ciphertext data to the decryption apparatus 600.

For example, the decryption apparatus 600 is a PC. The decryption apparatus 600 functions also as a decryption-key storage apparatus which receives the decryption key transmitted from the key generation apparatus 300 and stores the decryption key.

The decryption apparatus 600 receives the ciphertext data transmitted from the circuit-confidentiality homomorphic computation apparatus 500. Further, the decryption apparatus 600 obtains the computation result by decrypting the ciphertext data with use of the stored decryption key.

Note that, two or more of the public-parameter generation apparatus 200, the key generation apparatus 300, the encryption apparatuses 400, the circuit-confidentiality homomorphic computation apparatus 500, and the decryption apparatus 600 may be included in the same PC simultaneously.

As illustrated in FIG. 1, the confidential-information processing system 100 includes the public-parameter generation apparatus 200, the key generation apparatus 300, the encryption apparatuses 400, the circuit-confidentiality homomorphic computation apparatus 500, and the decryption apparatus 600.

Below, a functional configuration example of the public-parameter generation apparatus 200, a functional configuration example of the key generation apparatus 300, a functional configuration example of the encryption apparatuses 400, a functional configuration example of the circuit-confidentiality homomorphic computation apparatus 500, and a functional configuration example of the decryption apparatus 600 will be described in order.

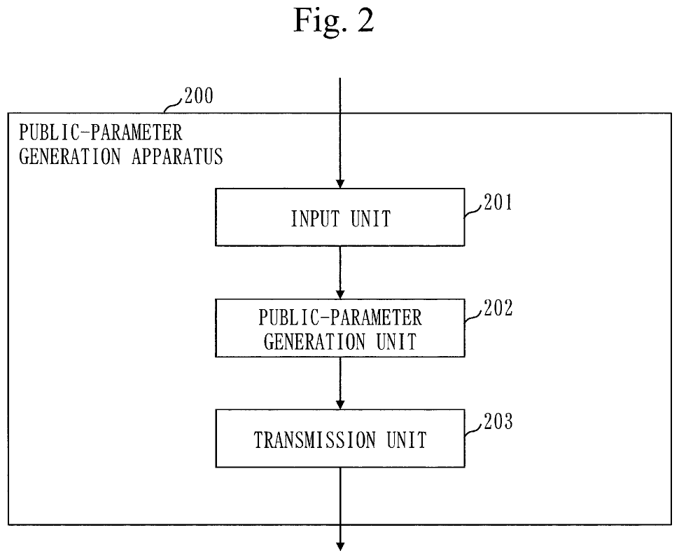

FIG. 2 illustrates the functional configuration example of the public-parameter generation apparatus 200.

As illustrated in FIG. 2, the public-parameter generation apparatus 200 includes an input unit 201, a public-parameter generation unit 202, and a transmission unit 203.

The public-parameter generation apparatus 200 includes a storage medium, not illustrated, which stores data used in each unit in the public-parameter generation apparatus 200.

The input unit 201 receives a security parameter λ and outputs the security parameter λ to the public-parameter generation unit 202.

The public-parameter generation unit 202 uses as input, the security parameter λ received from the input unit 201, and generates a public parameter PP for generating the encryption key and the decryption key. Further, the public-parameter generation unit 202 outputs the public parameter PP to the transmission unit 203.

To be accurate, the public-parameter generation unit 202 generates a public parameter PPᵢ for each integer i being i=1, . . . , N (N is an integer being 1 or larger). That is, the public-parameter generation unit 202 generates N public-parameters PP. Below, for simplification of descriptions, the public parameter PPᵢ is simply referred to as a public parameter PP unless it is necessary to mention the public parameter PPᵢ for each integer i.

The transmission unit 203 transmits the public parameter PP generated by the public-parameter generation unit 202, to the key generation apparatus 300, the encryption apparatus 400, and the circuit-confidentiality homomorphic computation apparatus 500.

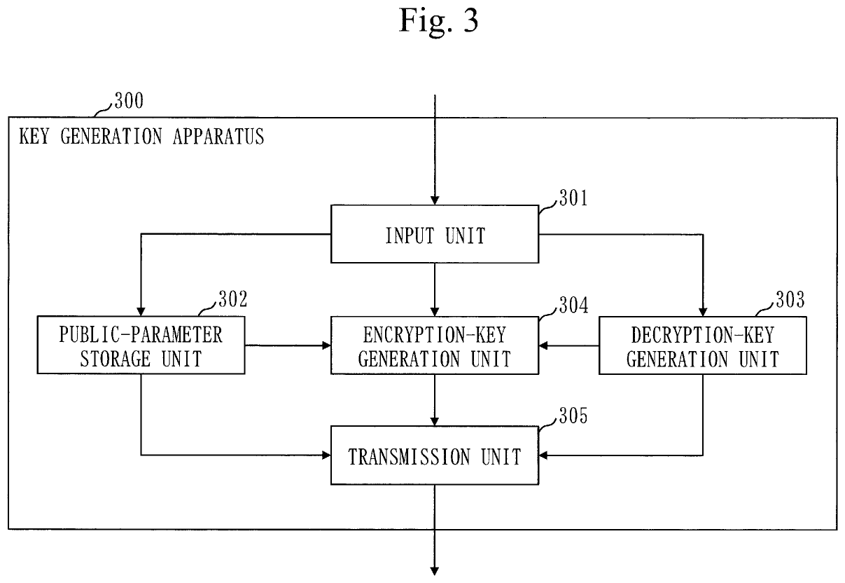

FIG. 3 illustrates the functional configuration example of the key generation apparatus 300.

As illustrated in FIG. 3, the key generation apparatus 300 includes an input unit 301, a public-parameter storage unit 302, a decryption-key generation unit 303, an encryption-key generation unit 304, and a transmission unit 305.

The key generation apparatus 300 includes a storage medium, not illustrated, which stores data used in each unit in the key generation apparatus 300.

The input unit 301 receives the public parameter PP and outputs the public parameter PP to the public-parameter storage unit 302. Also, the input unit 301 receives the security parameter λ and outputs the security parameter λ to the decryption-key generation unit 303.

The public-parameter storage unit 302 stores the public parameter PP received from the input unit 301.

The decryption-key generation unit 303 generates a decryption key SK. Further, the decryption-key generation unit 303 outputs the decryption key SK to the encryption-key generation unit 304 and the transmission unit 305.

To be accurate, the decryption-key generation unit 303 generates a decryption key SKᵢ for each integer i being i=1, . . . , N. That is, the decryption-key generation unit 303 generates N decryption keys SK. Below, for simplification of descriptions, the decryption key SKᵢ is simply referred to as a decryption key SK unless it is necessary to mention the decryption key SKᵢ for each integer i.

The encryption-key generation unit 304 uses as input, the decryption key SK received from the decryption-key generation unit 303 and generates an encryption key PK. Further, the encryption-key generation unit 304 outputs the encryption key PK to the transmission unit 305.

To be accurate, the encryption-key generation unit 304 generates an encryption key PKᵢ for each integer i being i=1, . . . , N. That is, the encryption-key generation unit 304 generates N encryption keys PK. Below, for simplification of descriptions, the encryption key PKᵢ is simply referred to as an encryption key PK unless it is necessary to mention the encryption key PKᵢ for each integer i.

The transmission unit 305 transmits the decryption key SK generated by the decryption-key generation unit 303, to the decryption apparatus 600.

Also, the transmission unit 305 transmits the encryption key PK generated by the encryption-key generation unit 304, to the encryption apparatus 400 and the circuit-confidentiality homomorphic computation apparatus 500.

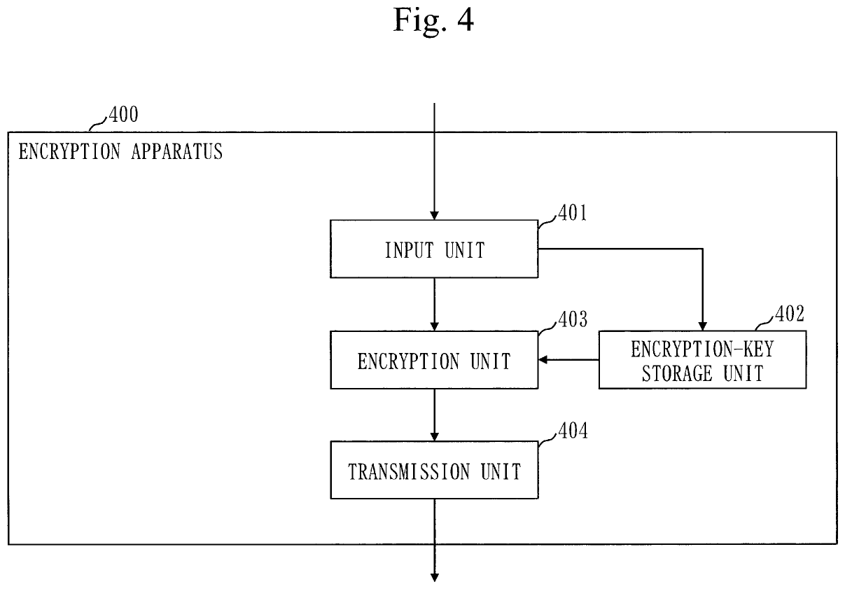

FIG. 4 illustrates the functional configuration example of the encryption apparatus 400.

As illustrated in FIG. 4, the encryption apparatus 400 includes an input unit 401, an encryption-key storage unit 402, an encryption unit 403, and a transmission unit 404.

The encryption apparatus 400 includes a storage medium, not illustrated, which stores data used in each unit in the encryption apparatus 400.

The input unit 401 receives the encryption key PK transmitted from the key generation apparatus 300 and outputs the encryption key PK to the encryption-key storage unit 402. Further, the input unit 401 receives plaintext data x and outputs the plaintext data x to the encryption unit 403.

Note that, a process performed by the input unit 401 is equivalent to an input process.

The encryption-key storage unit 402 stores the encryption key PK received from the input unit 401.

The encryption unit 403 receives the encryption key PK output from the encryption-key storage unit 402, and the plaintext data x and the public parameter PP which are output from the input unit 401. Then, the encryption unit 403 generates ciphertext data C of the plaintext data x and outputs the ciphertext data C to the transmission unit 404.

To be accurate, the encryption unit 403 generates ciphertext data Cᵢ of plaintext data xᵢ for each integer i being i=1, . . . , N. That is, the encryption unit 403 generates N pieces of encryption data C of N pieces of plaintext data x. Below, for simplification of descriptions, the plaintext data xᵢ and the ciphertext data Cᵢ for each integer i are simply referred to as plaintext data x and encryption data C unless it is necessary to mention the plaintext data xᵢ and the ciphertext data Cᵢ for each integer i.

A process performed by the encryption unit 403 is equivalent to an encryption process.

The transmission unit 404 receives the ciphertext data C from the encryption unit 403 and transmits the ciphertext data C to the circuit-confidentiality homomorphic computation apparatus 500.

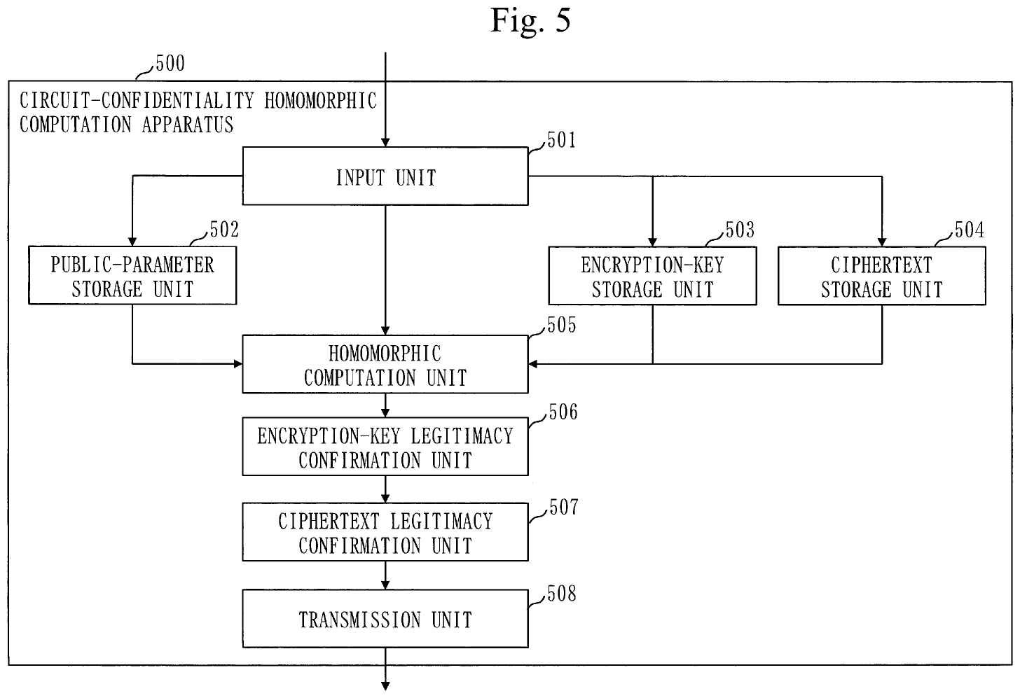

FIG. 5 illustrates the functional configuration example of the circuit-confidentiality homomorphic computation apparatus 500.

As illustrated in FIG. 5, the circuit-confidentiality homomorphic computation apparatus 500 includes an input unit 501, a public-parameter storage unit 502, an encryption-key storage unit 503, a ciphertext storage unit 504, a homomorphic computation unit 505, an encryption-key legitimacy confirmation unit 506, a ciphertext legitimacy confirmation unit 507, and a transmission unit 508.

The circuit-confidentiality homomorphic computation apparatus 500 includes a storage medium, not illustrated, which stores data used in each unit in the circuit-confidentiality homomorphic computation apparatus 500.

The input unit 501 receives the public parameter PP transmitted from the public-parameter generation apparatus 200 and outputs the received public parameter PP to the public-parameter storage unit 502. Further, the input unit 501 receives the encryption key PK transmitted from the key generation apparatus 300 and outputs the received encryption key PK to the encryption-key storage unit 503. Further, the input unit 501 receives the ciphertext data C transmitted from the encryption apparatus 400 and outputs the received ciphertext data C to the ciphertext storage unit 504. Further, the input unit 501 receives a function f and outputs the received function f to the homomorphic computation unit 505.

The public-parameter storage unit 502 stores the public parameter PP received from the input unit 501.

The encryption-key storage unit 503 stores the encryption key PK received from the input unit 501.

The ciphertext storage unit 504 stores the ciphertext data C received from the input unit 501.

The homomorphic computation unit 505 receives: the function f output from the input unit 501; the public parameter PPᵢ for each integer i being i=1, . . . , N, output from the public-parameter storage unit 502; the encryption key PKᵢ for each integer being i=1, . . . , N, output from the encryption-key storage unit 503; and the ciphertext data Cᵢ of the plaintext data xᵢ for each integer i being i=1, . . . , N, output from the ciphertext storage unit 504.

Then, the homomorphic computation unit 505 calculates ciphertext data C_{X} regarding computation result data X=f (x₁, . . . , x_{N}) obtained by applying the function f to all pieces of plaintext data xᵢ for each integer i being i=1, . . . , N.

Further, the homomorphic computation unit 505 outputs the ciphertext data C_{X} to the transmission unit 508.

Here, f (x₁, . . . , x_{N}) represents a result of computation which applies the function f to the N pieces of plaintext data x₁, . . . , x_{N}. Further, hereinafter, the ciphertext data C_{X} represents ciphertext data after homomorphic computation, of the computation result data X regarding an encryption-key set PK₁, . . . , PK_{N}. That is, the ciphertext data C_{X} is a computation result of the homomorphic computation on the N pieces of plaintext data x₁, . . . , x_{N}.

The computation result data X can be decrypted from the ciphertext data C_{X} by using all of the decryption keys SK₁, . . . , SK_{N}.

The transmission unit 508 transmits to the decryption apparatus 600, the ciphertext data C_{X} after the homomorphic computation, received from the homomorphic computation unit 505.

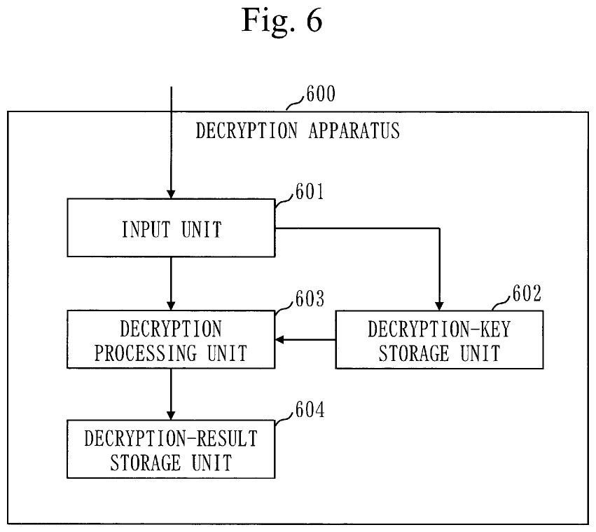

FIG. 6 illustrates the functional configuration example of the decryption apparatus 600.

As illustrated in FIG. 6, the decryption apparatus 600 includes an input unit 601, a decryption-key storage unit 602, a decryption processing unit 603, and a decryption-result storage unit 604.

The decryption apparatus 600 includes a storage medium, not illustrated, which stores data used in each unit in the decryption apparatus 600.

The input unit 601 receives the decryption key SK transmitted from the key generation apparatus 300. Further, the input unit 601 receives the ciphertext data C_{X} after the homomorphic computation, of the computation result data X regarding the encryption-key set PK1, . . . , PK_{N} transmitted from the circuit-confidentiality homomorphic computation apparatus 500.

The decryption-key storage unit 602 stores the decryption key SK received from the input unit 601.

The decryption processing unit 603 receives the ciphertext data C_{X} after the homomorphic computation, output from the input unit 601, and the decryption key SKᵢ for each integer i being i=1, . . . , N, output from the decryption-key storage unit 602. Then, the decryption processing unit 603 decrypts the ciphertext data C_{X} after the homomorphic computation, into the computation result data X which has been encrypted, using the decryption keys SK₁, . . . , SK_{N}, and outputs the computation result data X to the decryption-result storage unit 604.

The decryption-result storage unit 604 receives the computation result data X from the decryption processing unit 603 and stores it.

*** Description of Operation ***

Below, an operation of the confidential-information processing system 100 which is equivalent to a confidential-information processing method, according to the present embodiment will be described.

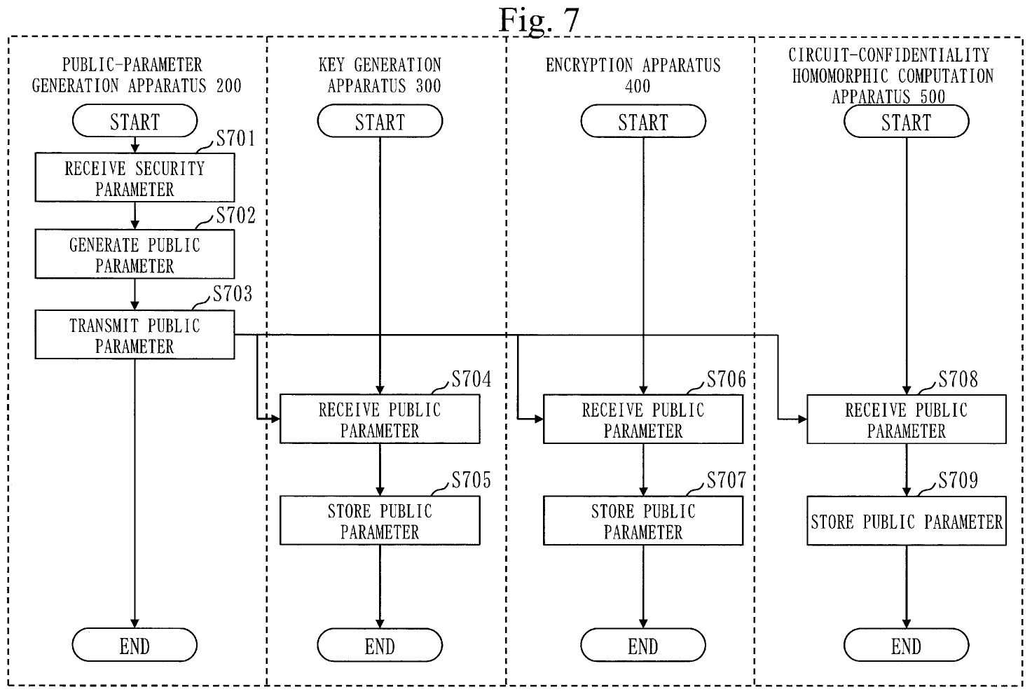

FIG. 7 is a flowchart indicating a generation process and a storage process of the public parameter in the confidential-information processing system 100.

Steps S701 to S709 in FIG. 7 are processes executed by the public-parameter generation apparatus 200, the key generation apparatus 300, the encryption apparatus 400, and the circuit-confidentiality homomorphic computation apparatus 500. Steps S701 to S703 are executed by the public-parameter generation apparatus 200. Steps S704 and S705 are executed by the key generation apparatus 300. Steps S706 and S707 are executed by the encryption apparatus 400. Steps S708 and S709 are executed by the circuit-confidentiality homomorphic computation apparatus 500.

In step S701, the input unit 201 of the public-parameter generation apparatus 200 receives the security parameter λ.

In step S702, the public-parameter generation unit 202 of the public-parameter generation apparatus 200 uses as input, the security parameter λ received by the input unit 201 of the public-parameter generation apparatus 200 in step S701, calculates an equation 1, and generates a public parameter PP represented by a matrix A.

[formula 1]

A← [symbol] _{q}^{m×n} equation 1

Here, n and q are integers being 1 or larger. m is an integer obtained from k×(λ²+1). k is an integer being 1 or larger, and λ is a security parameter. Z_{q}^{m×n} represents a set of matrixes of m×n having integers from 0 to (q−1) as elements.

That is, the public-parameter generation unit 202 randomly selects as the matrix A, a matrix from a plurality of Z_{q}^{m×n} and generates the public parameter PP.

In step S703, the transmission unit 203 of the public-parameter generation apparatus 200 receives the public parameter PP generated by the public-parameter generation unit 202 of the public-parameter generation apparatus 200.

Then, the transmission unit 203 transmits the public parameter PP to the key generation apparatus 300, the encryption apparatus 400, and the circuit-confidentiality homomorphic computation apparatus 500.

In step S704, the input unit 301 of the key generation apparatus 300 receives the public parameter PP transmitted by the transmission unit 203 of the public-parameter generation apparatus 200 in step S703.

In step S705, the public-parameter storage unit 302 of the key generation apparatus 300 stores the public parameter PP received by the input unit 301 of the key generation apparatus 300.

In step S706, the input unit 401 of the encryption apparatus 400 receives the public parameter PP transmitted by the transmission unit 203 of the public-parameter generation apparatus 200 in step S703.

In step S707, the encryption unit 403 of the encryption apparatus 400 stores the public parameter PP received by the input unit 401 of the encryption apparatus 400. The encryption unit 403 may extract a value q from the public parameter PP and store the value q only.

In step S708, the input unit 501 of the circuit-confidentiality homomorphic computation apparatus 500 receives the public parameter PP transmitted by the transmission unit 203 of the public-parameter generation apparatus 200.

In step S709, the public-parameter storage unit 502 of the circuit-confidentiality homomorphic computation apparatus 500 stores the public parameter PP received by the input unit 501 of the circuit-confidentiality homomorphic computation apparatus 500.

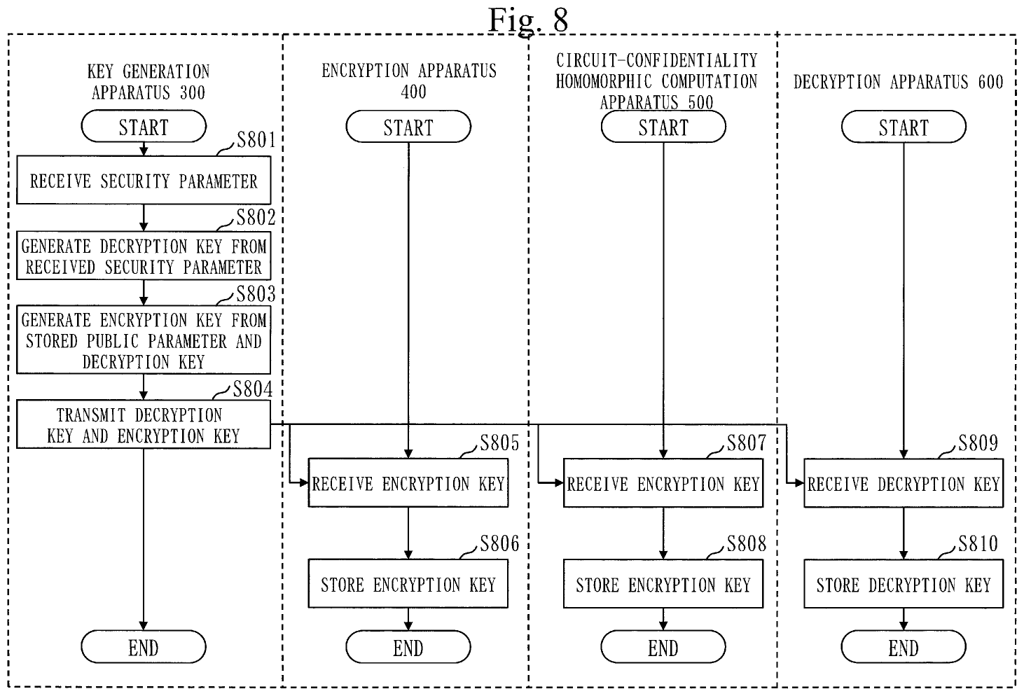

FIG. 8 is a flowchart illustrating generation and storage processes of the encryption key and the decryption key in the confidential-information processing system 100.

Steps S801 to S810 in FIG. 8 are processes executed by the key generation apparatus 300, the encryption apparatus 400, the circuit-confidentiality homomorphic computation apparatus 500, and the decryption apparatus 600. Steps S801 to S804 are executed by the key generation apparatus 300. Steps S805 and S806 are executed by the encryption apparatus 400. Steps S807 and S808 are executed by the circuit-confidentiality homomorphic computation apparatus 500. Steps S809 and S810 are executed by the decryption apparatus 600.

In step S801, the input unit 301 of the key generation apparatus 300 receives the security parameter λ.

In step S802, the decryption-key generation unit 303 of the key generation apparatus 300 uses as input, the security parameter λ received by the input unit 301 of the key generation apparatus 300 in step S801, calculates an equation 2, and generates the decryption key SK.

[formula 2]

SK=(1,−s) where s←{0,1}^{m-1} equation 2

Here, s←{0, 1}^{m-1} indicates that a vector s is randomly selected from a set of vectors each having (m−1) elements each of which is 0 or 1. (1, −s) represents a vector having m elements, which is obtained by concatenating an integer 1 and a vector −s.

That is, the decryption-key generation unit 303 randomly selects as the vector s, a vector from the set of vectors each having (m−1) elements each of which is 0 or 1, and generates as the decryption key SK, the vector having m elements, by concatenating the vector −s and the integer 1.

In step S803, the encryption-key generation unit 304 of the key generation apparatus 300 uses as input, the decryption key SK generated by the decryption-key generation unit 303 of the key generation apparatus 300 in step S802 and the public parameter PP stored in the public-parameter storage unit 302 of the key generation apparatus 300, and generates the encryption key PK. A matrix B included in the encryption key PK is calculated using an equation 3.

$$\begin{matrix}[ formula 3 ] & \\ B = A - [ \begin{matrix}{0}_{( m - 1 ) \times n} \\ SK \cdot A\end{matrix} ] & equation 3\end{matrix}$$

Here, 0_{(m-1)×n} represents a matrix of (m−1)×n, whose elements are all 0. SK·A represents a vector obtained from multiplying the decryption key SK by the matrix A of the public parameter PP.

That is, the encryption-key generation unit 304 generates the matrix B, using an equation 3, and generates the encryption key PK including the matrix B.

In step S804, the transmission unit 305 of the key generation apparatus 300 receives the decryption key SK generated by the decryption-key generation unit 303 of the key generation apparatus 300 in step S802 and the encryption key PK generated by the encryption-key generation unit 304 of the key generation apparatus 300 in step S803.

Then, the transmission unit 305 transmits the encryption key PK to the encryption apparatus 400 and the circuit-confidentiality homomorphic computation apparatus 500 and transmits the decryption key SK to the decryption apparatus 600.

In step S805, the input unit 401 of the encryption apparatus 400 receives the encryption key PK transmitted by the transmission unit 305 of the key generation apparatus 300 in step S804.

In step S806, the encryption-key storage unit 402 of the encryption apparatus 400 stores the encryption key PK received by the input unit 401 of the encryption apparatus 400 in step S805.

In step S807, the input unit 501 of the circuit-confidentiality homomorphic computation apparatus 500 receives the encryption key PK transmitted by the transmission unit 305 of the key generation apparatus 300 in step S804.

In step S808, the encryption-key storage unit 503 of the circuit-confidentiality homomorphic computation apparatus 500 stores the encryption key PK received by the input unit 501 of the circuit-confidentiality homomorphic computation apparatus 500 in step S807.

In step S809, the input unit 601 of the decryption apparatus 600 receives the decryption key SK transmitted by the transmission unit 305 of the key generation apparatus 300 in step S804.

In step S810, the decryption-key storage unit 602 of the decryption apparatus 600 stores the decryption key SK received by the input unit 601 of the decryption apparatus 600 in step S809.

Note that, since the decryption key SK is secret information, the decryption-key storage unit 602 of the decryption apparatus 600 needs to stringently store the decryption key SK so that it does not leak to the outside.

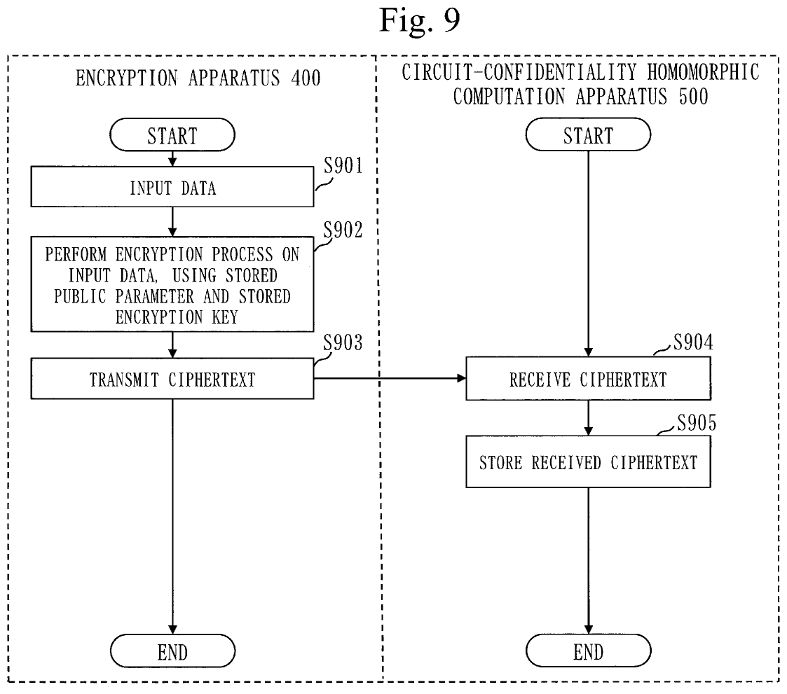

FIG. 9 is a flowchart illustrating ciphertext generation and storage processes in the confidential-information processing system 100.

Steps S901 to S905 in FIG. 9 are processes executed by the encryption apparatus 400 and the circuit-confidentiality homomorphic computation apparatus 500. Steps S901 to S903 are executed by the encryption apparatus 400. Steps S904 and S905 are executed by the circuit-confidentiality homomorphic computation apparatus 500.

In step S901, the input unit 401 of the encryption apparatus 400 obtains the plaintext x collected, for example, by the sensor or the like, and outputs the obtained plaintext data x to the encryption unit 403.

In step S902, the encryption unit 403 of the encryption apparatus 400 calculates an equation 4, using the plaintext data x provided by the input unit 401 in step S901 and the encryption key PK stored in the encryption-key storage unit 402, and generates the ciphertext data C. Calculation of the equation 4 is a process of adding to the plaintext data x, a matrix obtained by adding a random matrix having a small integer as elements, to a result of multiplying a uniformly random matrix by a random matrix having a small integer as elements.

[formula 4]

C=B·R+E+x·G equation 4

Here, B is the matrix B included in the encryption key PK. R and E are random-number matrixes generated by the encryption unit 403. G is a tensor product of (1, 2, . . . , 2^{L-1}) and an identity matrix of m×m. L is a minimum integer equal to or larger than log q. x is the plaintext data x.

That is, the encryption unit 403 generates the random-number matrix R and the random-number matrix E, and calculates the tensor product G of a vector (1, 2, . . . , 2^{L-1}) and the identity matrix of m×m. Then, the encryption unit 403 uses the matrix B, the random-number matrix R, the random-number matrix E, and the tensor product G, and generates the cipher data C of the plaintext data x, using the equation 1.

Note that, the encryption unit 403 generates the ciphertext data C which enables the circuit-confidentiality homomorphic computation apparatus 500 to verify that the matrix B has been generated by a legitimate generator (the key generation apparatus 300) and that the ciphertext data C has been generated by the encryption apparatus 400.

The encryption unit 403 outputs the generated ciphertext data C to the transmission unit 404 of the encryption apparatus 400.

In step S903, the transmission unit 404 of the encryption apparatus 400 receives the ciphertext data C output by the encryption unit 403 in step S902 and transmits the ciphertext data C to the circuit-confidentiality homomorphic computation apparatus 500.

In step S904, the input unit 501 of the circuit-confidentiality homomorphic computation apparatus 500 receives the ciphertext data C transmitted from the transmission unit 404 of the encryption apparatus 400 and outputs the ciphertext data C to the ciphertext storage unit 504.

In step S905, the ciphertext storage unit 504 of the circuit-confidentiality homomorphic computation apparatus 500 receives the ciphertext data C transmitted from the input unit 501 of the circuit-confidentiality homomorphic computation apparatus 500 in step S904 and stores the ciphertext data C.

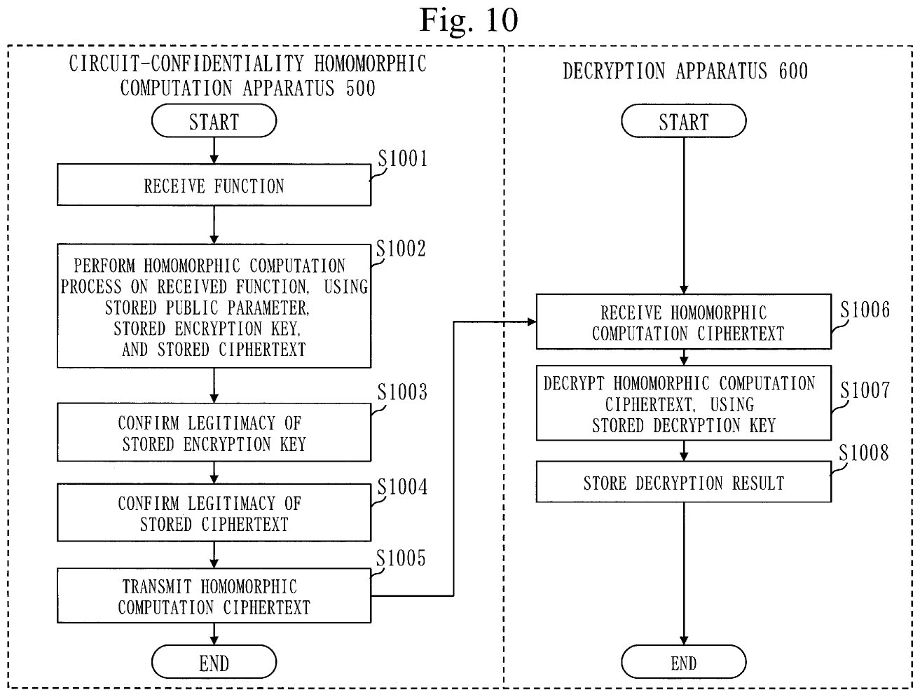

FIG. 10 is a flowchart indicating a homomorphic computation process and a decryption process in the confidential-information processing system 100.

Steps S1001 to S1008 in FIG. 10 are processes executed by the circuit-confidentiality homomorphic computation apparatus 500 and the decryption apparatus 600. Steps S1001 to S1005 are executed by the circuit-confidentiality homomorphic computation apparatus 500. Steps S1006 to S1008 are executed by the decryption apparatus.

In step S1001, the input unit 501 of the circuit-confidentiality homomorphic computation apparatus 500 receives the function f input from a keyboard, a mouse, a storage device, or the like, and transmits the function f to the homomorphic computation unit 505.

In step S1002, the homomorphic computation unit 505 of the circuit-confidentiality homomorphic computation apparatus 500 uses as input, the function f received from the input unit 501, the public parameters PP₁, . . . , PP_{N} stored in the public-parameter storage unit 502, the encryption keys PK₁, . . . , PK_{N} stored in the encryption-key storage unit 503, and the ciphertext data Cᵢ of the plaintext data xᵢ stored in the ciphertext storage unit 504 for all integers i being i=1, . . . , N, and generates ciphertext data C_{X} after homomorphic computation (hereinafter, simply referred to as ciphertext data C_{X}), of the computation result data X=f(x₁, . . . , x_{N}) regarding all of the encryption keys PK₁, . . . , PK_{N}. This calculation is realized by algorithm described in Non-Patent Literature 3.

Then, the homomorphic computation unit 505 outputs the ciphertext data C_{X} after the homomorphic computation to the encryption-key legitimacy confirmation unit 506.

In step S1003, the encryption-key legitimacy confirmation unit 506 of the circuit-confidentiality homomorphic computation apparatus 500 uses as input, the ciphertext data C_{X} after the homomorphic computation, received from the homomorphic computation unit 505, and the encryption keys PK₁, . . . , PK_{N} stored in the encryption-key storage unit 503, and verifies that a matrix Bᵢ included in the encryption key PKᵢ for all integers i being i=1, . . . , N has been generated by the key generation apparatus 300.

When it is verified that all of the matrixes Bᵢ have been generated by the key generation apparatus 300, the encryption-key legitimacy confirmation unit 506 outputs the ciphertext data C_{X} after the homomorphic computation to the ciphertext legitimacy confirmation unit 507.

When it is not verified that all of the matrixes Bᵢ have been generated by the key generation apparatus 300, the encryption-key legitimacy confirmation unit 506 outputs to the ciphertext legitimacy confirmation unit 507, ciphertext data C_{Y} of random plaintext data Y.

In step S1004, the ciphertext legitimacy confirmation unit 507 of the circuit-confidentiality homomorphic computation apparatus 500 uses as input, the ciphertext data C_{X} after the homomorphic computation, received from the encryption-key legitimacy confirmation unit 506, the encryption keys PK₁, . . . , PK_{N} stored in the encryption-key storage unit 503, and pieces of ciphertext data C₁, . . . , C_{N} stored in the ciphertext storage unit 504. Then, the ciphertext legitimacy confirmation unit 507 verifies that the ciphertext data Cᵢ for each integer i being i=1, . . . , N has been generated by the matrix Bᵢ included in the encryption key PKᵢ, that is, the ciphertext legitimacy confirmation unit 507 verifies that the ciphertext data Cᵢ has been generated by the encryption apparatus 400.

When it is verified that all of the pieces of ciphertext data Cᵢ have been generated by the matrix Bᵢ included in the encryption key PKᵢ, the ciphertext legitimacy confirmation unit 507 outputs the ciphertext data C_{X} after the homomorphic computation.

When it is not verified that all of the pieces of ciphertext data Cᵢ have been generated by the matrix Bᵢ included in the encryption key PKᵢ, the ciphertext legitimacy confirmation unit 507 outputs to the transmission unit 508, the ciphertext data C_{Y} of the random plaintext data Y.

Note that, when the ciphertext data C_{Y} of the random plaintext data Y is received from the encryption-key legitimacy confirmation unit 506, the ciphertext legitimacy confirmation unit 507 omits the process of step S1004 and outputs the ciphertext data C_{Y} to the transmission unit 508.

In step S1005, the transmission unit 508 of the circuit-confidentiality homomorphic computation apparatus 500 transmits to the decryption apparatus 600, the ciphertext data C_{X} after the homomorphic computation or the ciphertext data C_{Y} of the random plaintext data Y each of which has been output from the ciphertext legitimacy confirmation unit 507 in step S1004.

Here, details of the verification in step S1003 will be described.

The encryption key PKᵢ includes the ciphertext of the decryption key SKᵢ by the homomorphic cipher in addition to the matrix Bᵢ. The encryption-key legitimacy confirmation unit 506 uses the ciphertext while the ciphertext remains encrypted, and verifies that the matrix Bᵢ has been correctly generated.

Specifically, the encryption-key legitimacy confirmation unit 506 uses a ciphertext Cₛᵢ of SKᵢ=sᵢ while the ciphertext Cₛᵢ remains encrypted, and calculates a following function KValidate in a method described in Non-Patent Literature 3.

$$\begin{matrix}[ formula 5 ] & \\ KValidate ( {B}_{i} , {A}_{i} , {s}_{i} , {C}_{X} , {C}_{Y} ) = \{ \begin{matrix}{C}_{X} if {B}_{i} = {A}_{i} - [ \begin{matrix}{0}_{( m - 1 ) \times n} \\ {s}_{i} {A}_{i}\end{matrix} ] \\ {C}_{Y} otherwise .\end{matrix} & equation 5\end{matrix}$$

Here, Aᵢ is the matrix A of the public parameter PPᵢ, and Bᵢ is a matrix B included in the encryption key PKᵢ.

Next, details of the verification in step S1004 will be described.

The ciphertext data C_{X} includes, in addition to the ciphertext data Cᵢ of the plaintext data xᵢ, ciphertext C_{R} and ciphertext C_{E} which are ciphertexts in the homomorphic cipher of the random-number matrix R and the random-number matrix E used for generating the ciphertext data Cᵢ. The ciphertext legitimacy confirmation unit 507 uses the ciphertext C_{R} and the ciphertext C_{E} while the ciphertext C_{R} and the ciphertext C_{E} remain encrypted, and confirms that the ciphertext data Cᵢ has been correctly generated.

Specifically, the ciphertext legitimacy confirmation unit 507 uses a ciphertext C_{Ri} and a ciphertext C_{Ei} of a random-number matrix Rᵢ and a random-number matrix Eᵢ while the ciphertext C_{Ri} and the ciphertext C_{Ei} remain encrypted, and calculates a following function CValidate in a method described in Non-Patent Literature 3.

$$\begin{matrix}[ formula 6 ] & \\ CValidate ( {B}_{i} , {R}_{i} , {E}_{i} , {x}_{i} , {C}_{X} , {C}_{Y} ) = \{ \begin{matrix}{C}_{X} if {C}_{i} = {B}_{i} {R}_{i} + {E}_{i} + xG \\ {C}_{Y} otherwise .\end{matrix} & equation 6\end{matrix}$$

Here, Rᵢ is the random-number matrix R used for generating the matrix Bᵢ, and Eᵢ is the random-number matrix E used for generating the matrix Bᵢ.

In step S1006, the input unit 601 of the decryption apparatus 600 receives the ciphertext data C_{X} after the homomorphic computation or the ciphertext data C_{Y} of the random plaintext data Y, each of which has been transmitted from the transmission unit 508 of the circuit-confidentiality homomorphic computation apparatus 500 in step S1005. Then, the input unit 601 outputs the ciphertext data C_{X} after the homomorphic computation or the ciphertext data C_{Y} to the decryption processing unit 603.

In step S1007, the decryption processing unit 603 of the decryption apparatus 600 uses as input, the decryption keys SK₁, . . . , SK_{N} stored in the decryption-key storage unit 602 of the decryption apparatus 600, performs a decryption process by algorithm described in Non-Patent Literature 3, on the ciphertext data C_{X} after the homomorphic computation or the ciphertext data C_{Y} of the random plaintext data Y, each of which has been transmitted from the input unit 601 of the decryption apparatus 600 in step S1006, and obtains a decryption result X or the random plaintext data Y.

Here, the decryption result X=f(x₁, . . . , x_{N}) or the random plaintext data Y can be obtained from the ciphertext data C_{X} after the homomorphic computation or the encryption keys PK₁, . . . , PK_{N} of the ciphertext data C_{Y}, only in a case where the encryption-key generation unit 304 of the key generation apparatus 300 has generated the encryption key PKᵢ, using the decryption key SKᵢ, for each integer i being i=1, . . . , N.

The decryption processing unit 603 outputs the decryption result X or the random plaintext data Y to the decryption-result storage unit 604.

In step S1008, the decryption-result storage unit 604 of the decryption apparatus 600 stores the decryption result X or the random plaintext data Y each of which has been output from the decryption processing unit 603 of the decryption apparatus 600 in step S910.

The decryption apparatus 600 accepts only the ciphertext after the homomorphic computation as input. However, when the ciphertext before the homomorphic computation is required to be decrypted, the decryption apparatus 600 requests the circuit-confidentiality homomorphic computation apparatus 500 to perform the homomorphic computation as to computation which outputs the same value as input without any change. Then, the decryption apparatus 600 decrypts the obtained ciphertext after the homomorphic computation in the same way as the process in step S910. Consequently, it is possible to decrypt the plaintext data of the ciphertext before the homomorphic computation.

In step S1008, the homomorphic computation process and the decryption process in the confidential-information processing system 100 end.

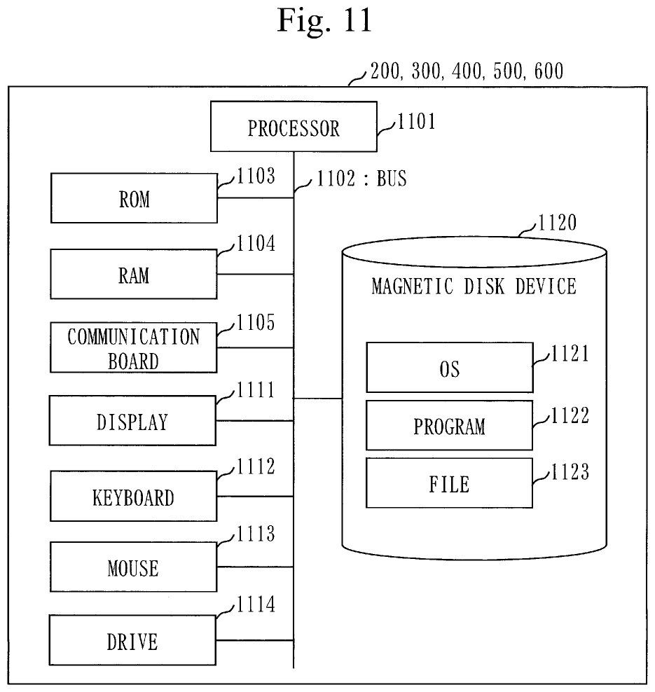

FIG. 11 is a diagram illustrating examples of hardware resources in the public-parameter generation apparatus 200, the key generation apparatus 300, the encryption apparatus 400, the circuit-confidentiality homomorphic computation apparatus 500, and the decryption apparatus 600 in the first embodiment.

In FIG. 11, each of the public-parameter generation apparatus 200, the key generation apparatus 300, the encryption apparatus 400, the circuit-confidentiality homomorphic computation apparatus 500, and the decryption apparatus 600 includes a processor 1101. For example, the processor 1101 is a CPU (Central Processing Unit). The processor 1101 is connected to hardware devices such as a ROM 1103, a RAM 1104, a communication board 1105, a display 1111 (display device), a keyboard 1112, a mouse 1113, a drive 1114, and a magnetic disk device 1120 via a bus 1102, and controls these hardware devices.

The drive 1114 is a device which reads and writes on a storage medium such as an FD (Flexible Disk Drive), a CD (Compact Disc), or a DVD (Digital Versatile Disc).

The ROM 1103, the RAM 1104, the magnetic disk device 1120, and the drive 1114 are examples of the storage device.

The keyboard 1112, the mouse 1113, and the communication board 1105 are examples of the input device. The display 1111 and the communication board 1105 are examples of the output device.

The communication board 1105 is connected to communication networks such as a LAN (Local Area Network), the Internet, and a telephone line, in a wired or wireless way.

The magnetic disk device 1120 stores an OS (Operating System) 1121, a program 1122, and a file 1123.

The program 1122 includes a program which executes a function described as “ . . . unit” in the present embodiment. The program is read and executed by the processor 1101. That is, the program causes a computer to function as “ . . . unit” and to execute a procedure or a method of “ . . . unit”. The program may be stored in a portable storage medium such as a magnetic disk, a flexible disk, an optical disc, a compact disc, a blue-ray (registered trademark) disc, or the DVD. Then the portable storage medium storing the program may be distributed.

The file 1123 includes various types of data (input, output, a determination result, a calculation result, a processing result, and the like) used by “ . . . unit” described in the present embodiment.

Arrows included in a configuration diagram and a flowchart in the present embodiment mainly indicate input/output of pieces of data or signals.

Processes in the present embodiment, described based on the flowcharts are executed using pieces of hardware such as the processor 1101, the storage device, the input device, and the output device.

A part described as “ . . . unit” in the present embodiment may be “ . . . circuit”, “ . . . device”, and “ . . . equipment”, and may also be “ . . . step”, “ . . . procedure”, and “ . . . process”. That is, the part described as “ . . . unit” may be implemented as any of firmware, software, hardware, and a combination of these.

Each of the public-parameter generation apparatus 200, the key generation apparatus 300, the encryption apparatus 400, the circuit-confidentiality homomorphic computation apparatus 500, and the decryption apparatus 600 may be realized by a processing circuit. For example, the processing circuit is a logic IC (Integrated Circuit), a GA (Gate Array), an ASIC (Application Specific Integrated Circuit), or an FPGA (Field-Programmable Gate Array).

Note that, in the present specification, a superordinate concept of the processor and the processing circuit is referred to as “processing circuitry”.

That is, each of the processor and the processing circuit is a specific example of the “processing circuitry”.

### Description of Effect of Embodiment

According to the present embodiment, it is possible to realize a strong-circuit-confidentiality homomorphic cipher technique which can perform the homomorphic computation on the ciphertexts encrypted using the different encryption keys and is secure against a quantum computer.

The confidential-information processing system 100 according to the present embodiment internally uses circuit-confidentiality homomorphic cipher in which the ciphertext is represented by a matrix, which is secure against the quantum computer.

Therefore, according to the present embodiment, a homomorphic cipher method which has strong circuit confidentiality also has security against the quantum computer. A conventional technique internally uses the circuit-confidentiality homomorphic cipher which is not secure against the quantum computer, therefore, it does not have such security.

More specifically, security against the quantum computer can be obtained from the above equation 4. Generally, security of the cipher is secured by difficulty to solve a calculation problem. Existence of quantum algorithm which solves a problem (specifically, a problem called a learning-with-errors problem) defined using a matrix is not recognized. Thus, the plaintext data x cannot be obtained from the ciphertext data C calculated according to the equation 4.

Further, the strong circuit confidentiality is a characteristic of preventing leakage of information on a function to be calculated with (the function fin the present specification), when encrypted input into the computation is not correctly generated. The encryption-key legitimacy confirmation unit 506 and the ciphertext legitimacy confirmation unit 507 verify that the input (the encryption key and the ciphertext data) into the computation has been correctly generated. In the present embodiment, when the encryption key or the ciphertext data is not correctly generated, the ciphertext data C_{Y} of the random plaintext data Y is output. Therefore, even when the encryption key or the ciphertext data is not correctly generated, the information on the function f does not leak.

Further, in the confidential-information processing system 100 according to the present embodiment, the circuit-confidentiality homomorphic computation apparatus 500 generates the ciphertext data C_{X} of a correct calculation result of the function f which is given as input, only for the encryption key generated by the key generation apparatus 300 and the ciphertext data generated by the encryption apparatus 400.

Therefore, according to the present embodiment, when a malicious data provider inputs illegitimate data into the circuit-confidentiality homomorphic computation apparatus 500, the ciphertext data C_{Y} of the random plaintext data Y is generated. Thus, the malicious data provider cannot extract the plaintext data x before computation circuit calculation, and the security is enhanced according to the present embodiment.

In the present embodiment, it is possible to perform a computation process on ciphertexts which have been encrypted using different encryption keys, while the ciphertexts remain encrypted. Conventionally, the computation process can be performed only on ciphertexts which have been encrypted using the same encryption keys.

In the present embodiment, the homomorphic computation unit 505 of the circuit-confidentiality homomorphic computation apparatus 500 performs the homomorphic computation, using the method described in Non-Patent Literature 3. Therefore, it is possible to perform the computation process on the ciphertexts which have been encrypted using the different encryption keys, while the ciphertexts remain encrypted. Note that, Non-Patent Literature 3 describes an encryption method of enabling the homomorphic computation on the ciphertexts which have been encrypted using the different encryption keys.

Therefore, according to the present embodiment, when computation is made on pieces of confidential information from a plurality of data providers while the pieces of confidential information remain encrypted, the decryption keys do not need to be shared between the data providers. Thus, the security is enhanced according to the present embodiment.

### REFERENCE SIGNS LIST

100: confidential-information processing system, 101: Internet, 200: public-parameter generation apparatus, 201: input unit, 202: public-parameter generation unit, 203: transmission unit, 300: key generation apparatus, 301: input unit, 302: public-parameter storage unit, 303: decryption-key generation unit, 304: encryption-key generation unit, 305: transmission unit, 400: encryption apparatus, 401: input unit, 402: encryption-key storage unit, 403: encryption unit, 404: transmission unit, 500: circuit-confidentiality homomorphic computation apparatus, 501: input unit, 502: public-parameter storage unit, 503: encryption-key storage unit, 504: ciphertext storage unit, 505: homomorphic computation unit, 506: encryption-key legitimacy confirmation unit, 507: ciphertext legitimacy confirmation unit, 508: transmission unit, 600: decryption apparatus, 601: input unit, 602: decryption-key storage unit, 603: decryption processing unit, 604: decryption-result storage unit, 1101: processor, 1102: bus, 1103: ROM, 1104: RAM, 1105: communication board, 1111: display, 1112: keyboard, 1113: mouse, 1114: drive, 1120: magnetic disk device, 1121: OS, 1122: program, 1123: file.

1. A confidential-information processing system comprising:
an encryption apparatus to generate ciphertext data C of plaintext data x by an equation 1, using a matrix B included in an encryption key PK used for homomorphic computation, a random-number matrix R, a random-number matrix E, and a tensor product G of a predetermined vector and a predetermined identity matrix
C=B·R+E+x·G equation 1; and
a circuit-confidentiality homomorphic computation apparatus to perform the homomorphic computation for the plaintext data x, using the encryption key PK and the ciphertext data C, and generate ciphertext data C_{X} as a computation result of the homomorphic computation.

2. The confidential-information processing system according to claim 1, wherein
the encryption apparatus generates the ciphertext data C which enables the circuit-confidentiality homomorphic computation apparatus to verify that the matrix B has been generated by a legitimate generator and that the ciphertext data C has been generated by the encryption apparatus, and
the circuit-confidentiality homomorphic computation apparatus outputs the ciphertext data C_{X} to a predetermined output destination when the both are verified of that the matrix B has been generated by the legitimate generator and that the ciphertext data C has been generated by the encryption apparatus.

3. The confidential-information processing system according to claim 2, wherein
the circuit-confidentiality homomorphic computation apparatus outputs ciphertext data C_{Y} of random plaintext data Y to the output destination when at least one is not verified of that the matrix B has been generated by the legitimate generator and that the ciphertext data C has been generated by the encryption apparatus.

4. The confidential-information processing system according to claim 1, wherein
when k is an integer being 1 or larger, λ is a security parameter, m is an integer obtained from k×(λ²+1), and each of n and q is an integer being 1 or larger, a matrix A is randomly selected from among a plurality of Z_{q}^{m×n} each of which is a matrix of m×n having integers from 0 to (q−1) as elements, and a public parameter PP is generated,
a vector s is randomly selected from a set of vectors each having (m−1) elements each of which is 0 or 1, a vector-s and an integer 1 are concatenated, and a vector having m elements is generated as a decryption key SK to be used for decrypting the ciphertext data C_{X},
when 0_{(m-1)×n} represents a matrix of (m−1)×n each element of which is 0, and SK·A represents a vector obtained from multiplying the decryption key SK by the matrix A of the public parameter PP, the matrix B is generated by an equation 2, and the encryption key PK including the matrix B is generated, and
$$\begin{matrix}[ formula 1 ] & \\ B = A - [ \begin{matrix}{0}_{( m - 1 ) \times n} \\ SK \cdot A\end{matrix} ] & equation 2\end{matrix}$$
the encryption apparatus acquires the encryption key PK including the matrix B, and generates the ciphertext data C.

5. The confidential-information processing system according to claim 4, wherein
when L is a minimum integer which is equal to or larger than log q, the encryption apparatus generates a tensor product G of (1, 2, . . . , 2^{L-1}) and an identity matrix of m×m and generates the ciphertext data C.

6. The confidential-information processing system according to claim 1, further comprising:
a public-parameter generation apparatus to select a matrix A randomly from among a plurality of Z_{q}^{m×n} each of which is a matrix of m×n having integers from 0 to (q−1) as elements, and generate a public parameter PP, when k is an integer being 1 or larger, λ is a security parameter, m is an integer obtained from k×(λ²+1), and each of n and q is an integer being 1 or larger; and
a key generation apparatus to
select a vector s randomly from a set of vectors each having (m−1) elements each of which is 0 or 1, concatenate a vector-s and an integer 1, and generate a vector having m elements as a decryption key SK to be used for decrypting the ciphertext data C_{X}, and
generate the matrix B by an equation 3 and generate the encryption key PK including the matrix B, when 0_{(m-1)×n} represents a matrix of (m−1)×n each element of which is 0, and SK·A represents a vector obtained from multiplying the decryption key SK by the matrix A of the public parameter PP, and wherein
the encryption apparatus acquires the public parameter PP from the public-parameter generation apparatus, acquires the encryption key PK including the matrix B from the key generation apparatus, and generates the ciphertext data C.
$$\begin{matrix}[ formula 2 ] & \\ B = A - [ \begin{matrix}{0}_{( m - 1 ) \times n} \\ SK \cdot A\end{matrix} ] & equation 3\end{matrix}$$

7. The confidential-information processing system according to claim 6, wherein
the encryption apparatus generates the ciphertext data C which enables the circuit-confidentiality homomorphic computation apparatus to verify that the matrix B has been generated by the key generation apparatus and that the ciphertext data C has been generated by the encryption apparatus, and
the circuit-confidentiality homomorphic computation apparatus outputs the ciphertext data C_{X} to a predetermined output destination when the both are verified of that the matrix B has been generated by the key generation apparatus and that the ciphertext data C has been generated by the encryption apparatus.

8. The confidential-information processing system according to claim 7, wherein
the circuit-confidentiality homomorphic computation apparatus outputs ciphertext data C_{Y} of random plaintext data Y to the output destination when at least one is not verified of that the matrix B has been generated by the key generation apparatus and that the ciphertext data C has been generated by the encryption apparatus.

9. An encryption apparatus comprising:
processing circuitry
to acquire an encryption key PK which includes a matrix B and is used for homomorphic computation, and acquire plaintext data x; and
to generate ciphertext data C of the plaintext data x by an equation 4, using the matrix B, a random-number matrix R, a random-number matrix E, and a tensor product G of a predetermined vector and a predetermined identity matrix.
C=B·R+E+x·G equation 4

10. An encryption method comprising:
acquiring an encryption key PK which includes a matrix B and is used for homomorphic computation, and acquiring plaintext data x; and
generating ciphertext data C of the plaintext data x by an equation 5, using the matrix B, a random-number matrix R, a random-number matrix E, and a tensor product G of a predetermined vector and a predetermined identity matrix.
C=B·R+E+x·G equation 5

11. A non-transitory computer readable medium storing an encryption program which causes a computer to execute:
an input process of acquiring an encryption key PK which includes a matrix B and is used for homomorphic computation, and acquiring plaintext data x; and
an encryption process of generating ciphertext data C of the plaintext data x by an equation 6, using the matrix B, a random-number matrix R, a random-number matrix E, and a tensor product G of a predetermined vector and a predetermined identity matrix.
C=B·R+E+x·G equation 6
